(19) United States
(12) Patent Application Publication
(10) Pub. No.: US 2020/0306781 A1
(43) Pub. Date: Oct. 1, 2020

(54) COLOR CODED SPRAYER SYSTEM

(71) Applicant: THE FOUNTAINHEAD GROUP, INC., New York Mills, NY (US)

(72) Inventors: Jason Bonaventura, Oneida, NY (US); Jeffrey D. Nocolia, Oneida, NY (US)

(73) Assignee: THE FOUNTAINHEAD GROUP, INC., New York Mills, NY (US)

(21) Appl. No.: 16/833,931

(22) Filed: Mar. 30, 2020

Related U.S. Application Data
(60) Provisional application No. 62/826,281, filed on Mar. 29, 2019.

(51) Int. Cl. B05B 12/14; B05B 1/02

(52) U.S. Cl. CPC B05B 12/1409; B05B 1/02

(57) ABSTRACT

A color coded sprayer system, wherein each sprayer is printed with a particular color ink in regard to the type of chemical used in that tank, a cap for sealing the tank when not in use, a shut-off, and a spray nozzle, all of which match the color of the printing, thereby providing the user with visual cues of the chemicals stored in the tank.

### CROSS-REFERENCE TO RELATED APPLICATION

The present application relates and claims priority to U.S. Provisional Application No. 62/826,281, filed Mar. 29, 2019, the entirety of which is hereby incorporated by reference.

### FIELD OF THE INVENTION

The present disclosure is directed generally to lawn and garden sprayers, and more particularly to a system of sprayers wherein each sprayer in the system is used for a discreet type of spraying.

### BACKGROUND

Lawn and garden areas are often treated with liquid fertilizer, herbicides and pesticides to help maintain the health of the lawn or garden. There are several different types of fertilizer, herbicide and pesticide with each performing a different function as compared to the others. Those maintaining the lawn and garden, however, often will have only a single spray tank that they will fill with the concentrated chemical and water and dispense using the sprayer that came with the spray tank. Using the spray tank for the different chemicals will typically result in at least a small amount of cross-contamination, wherein the residues from the last chemical used will remain in the tank even after a cleaning, and then mix with the new chemical that is to be used. Over time, this cross-contamination worsens.

In addition to the cross-contamination, another issue with using a single spray tank and sprayer is that quite often less than an entire tank full of chemical is used and then the spray tank is stored until used again. Unless the tank has been labelled, it is possible that the user will not remember what chemical was mixed in the tank. Thus, the possibility of spraying an undesired chemical on the lawn and garden results.

Accordingly, there is a need in the art for a spray system that provides users with the ability to use the proper chemical for the desired job, while avoiding confusion relative to what chemical mixture is in a spray tank.

### SUMMARY

The present disclosure is directed to a color coded sprayer system, wherein each sprayer is printed with a particular color ink in regard to the type of chemical used in that tank, a cap, a shut-off, and a spray nozzle, all of which match the color of the printing, thereby providing the user with visual cues of the chemicals stored in the tank.

According to an aspect is a spray tank system comprising a first tank having a first opening, wherein the first tank contains printing thereon in a first color indicative of a first chemical that the first tank is adapted to contain, and a first cap of the first color that is adapted to be placed in sealed relation to the first opening when the first tank is not in use; and a second tank having a second opening, wherein the second tank contains printing thereon in a second color indicative of a second chemical that the second tank is adapted to contain, and a second cap of the second color that is adapted to be placed in sealed relation to the second opening when the second tank is not in use.

According to an embodiment, the spray tank system further comprises a first spray nozzle being of the first color and adapted to operably attach to the first tank; and a second spray nozzle being of the second color and adapted to operably attach to the second tank.

According to an embodiment, the spray tank system further comprises a first shut-off being of the first color and adapted to operably attach to the first tank; and a second shut-off being of the second color and adapted to operably attach to the second tank.

According to an embodiment, the spray tank system further comprises a third tank having a third opening, wherein the third tank contains printing thereon in a third color indicative of a third chemical, different from the first and second chemicals, that the third tank is adapted to contain, and a third cap of the third color, different from the first and second colors, that is adapted to be placed in sealed relation to the third opening when the third tank is not in use.

According to an embodiment, the spray tank system further comprises a third spray nozzle being of the third color and adapted to operably attach to the third tank

According to an embodiment, the spray tank system further comprises a third shut-off being of the third color and adapted to operably attach to the third tank.

According to an aspect is a spray tank system comprising a first tank having a first opening, wherein the first tank contains printing thereon in a first color indicative of a first chemical that the first tank is adapted to contain, and a first spray nozzle being of the first color and adapted to operably attach to the first tank; and a second tank having a second opening, wherein the second tank contains printing thereon in a second color indicative of a second chemical that the second tank is adapted to contain, and a second spray nozzle being of the second color and adapted to operably attach to the second tank.

According to an embodiment, the spray tank system further comprises a third tank having a third opening, wherein the third tank contains printing thereon in a third color indicative of a third chemical that the third tank is adapted to contain, and a third spray nozzle being of the third color and adapted to operably attach to the third tank.

According to an aspect is a spray tank system comprising a first tank adapted to retain a first chemical therein, having a first opening, a first cap adapted to be placed in sealed relation over the first opening, a first spray nozzle adapted to operably attach to the first tank, and a first shut off for selectively shutting off the flow of fluid to the first spray nozzle, wherein at least one of the first tank, the first cap, the first spray nozzle and the first shut-off are of a first color indicative of the first chemical; and a second tank adapted to retain a second chemical, different than the first chemical, therein, having a second opening, a second cap adapted to be placed in sealed relation over the second opening, a second spray nozzle adapted to operably attach to the second tank, and a second shut off for selectively shutting off the flow of fluid to the second spray nozzle, wherein at least one of the second tank, the second cap, the second spray nozzle and the second shut-off are of a second color, different from the first color, indicative of the second chemical.

According to an embodiment, the spray tank system further comprises a third tank adapted to retain a third chemical, different than the first and second chemicals, therein, having a third opening, a third cap adapted to be placed in sealed relation over the third opening, a third spray nozzle adapted to operably attach to the third tank, and a third shut off for selectively shutting off the flow of fluid to the third spray nozzle, wherein at least one of the third tank, the third cap, the third spray nozzle and the third shut-off are of a third color, different from the first and second colors, indicative of the third chemical.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of the spray tank system, in accordance with an embodiment.

### DETAILED DESCRIPTION OF EMBODIMENTS

The present disclosure describes a color coded sprayer system, wherein each sprayer is printed with a particular color ink in regard to the type of chemical used in that tank, a cap for sealing the tank when not in use, a shut-off, and a spray nozzle, all of which match the color of the printing, thereby providing the user with visual cues of the chemicals stored in the tank.

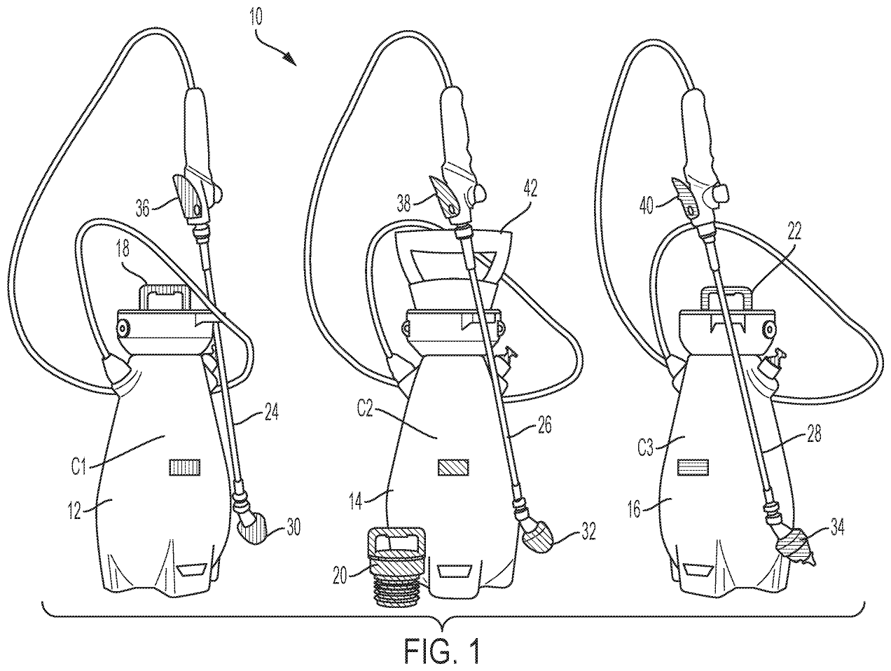

Referring to FIG. 1, in one embodiment, is a system of spray tanks, designated generally by reference numeral 10, comprising three tanks, 12, 14, 16, each of which is imprinted with a distinctive color ink (in this example, tank 12 in red (C1), tank 14 in green (C2), and tank 16 in blue (C3)), each of which includes a cap 18, 20, 22, respectively, that is of the same color as the printing for the particular tank to which it attaches, a spray wand, 24, 26, 28, respectively, each having a respective nozzle 30, 32, 34 and shut-off 36, 38, and 40 of the same color as the printing and cap. Each tank 12, 14, 16 is intended to be used to store and dispense a particular type of chemical such as a pesticide (tank 12), an herbicide (tank 14), or a cleaning composition (tank 16), for example. When each tank 12, 14, 16 is not in use, its opening through which water and the chemical concentrate is poured, is closed by the corresponding cap 18, 20, 22, respectively. When the tank 12, 14 or 16 is in use, the corresponding cap 18, 20, 22, is removed and replaced with the operating pump 42 (shown in FIG. 1 attached to tank 14). The system could comprise only two tanks (for example, pesticide and herbicide), or any other number of tanks depending on the number of types of chemicals one commonly uses).

The preferred system can be modified such that any number of the tank components are color coded to represent the type of chemical intended to be stored therein and sprayed therefrom.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A spray tank system, comprising:
a. a first tank having a first opening, wherein the first tank contains printing thereon in a first color indicative of a first chemical that the first tank is adapted to contain, and a first cap of the first color that is adapted to be placed in sealed relation to the first opening when the first tank is not in use;
b. a second tank having a second opening, wherein the second tank contains printing thereon in a second color, different from the first color, indicative of a second chemical, different from the first chemical, that the second tank is adapted to contain, and a second cap of the second color that is adapted to be placed in sealed relation to the second opening when the second tank is not in use.

2. The spray tank system according to claim 1, further comprising:
a. a first spray nozzle being of the first color and adapted to operably attach to the first tank; and
b. a second spray nozzle being of the second color and adapted to operably attach to the second tank.

3. The spray tank system according to claim 2, further comprising:
a. a first shut-off being of the first color and adapted to operably attach to the first tank; and
b. a second shut-off being of the second color and adapted to operably attach to the second tank.

4. The spray tank system according to claim 1, further comprising a third tank having a third opening, wherein the third tank contains printing thereon in a third color indicative of a third chemical, different from the first and second chemicals, that the third tank is adapted to contain, and a third cap of the third color, different from the first and second colors, that is adapted to be placed in sealed relation to the third opening when the third tank is not in use.

5. The spray tank system according to claim 4, further comprising a third spray nozzle being of the third color and adapted to operably attach to the third tank.

6. The spray tank system according to claim 5, further comprising a third shut-off being of the third color and adapted to operably attach to the third tank.

7. A spray tank system, comprising:
a. a first tank having a first opening, wherein the first tank contains printing thereon in a first color indicative of a first chemical that the first tank is adapted to contain, and a first spray nozzle being of the first color and adapted to operably attach to the first tank;
b. a second tank having a second opening, wherein the second tank contains printing thereon in a second color indicative of a second chemical that the second tank is adapted to contain, and a second spray nozzle being of the second color and adapted to operably attach to the second tank.

8. The spray tank system according to claim 7, further comprising a third tank having a third opening, wherein the third tank contains printing thereon in a third color indicative of a third chemical that the third tank is adapted to contain, and a third spray nozzle being of the third color and adapted to operably attach to the third tank.

9. A spray tank system, comprising:
a. a first tank adapted to retain a first chemical therein, having a first opening, a first cap adapted to be placed in sealed relation over the first opening, a first spray nozzle adapted to operably attach to the first tank, and a first shut off for selectively shutting off the flow of fluid to the first spray nozzle, wherein at least one of the first tank, the first cap, the first spray nozzle and the first shut-off are of a first color indicative of the first chemical; and
b. a second tank adapted to retain a second chemical, different than the first chemical, therein, having a second opening, a second cap adapted to be placed in sealed relation over the second opening, a second spray nozzle adapted to operably attach to the second tank, and a second shut off for selectively shutting off the flow of fluid to the second spray nozzle, wherein at least one of the second tank, the second cap, the second spray nozzle and the second shut-off are of a second color, different from the first color, indicative of the second chemical.

10. The spray tank system according to claim 9, further comprising a third tank adapted to retain a third chemical, different than the first and second chemicals, therein, having a third opening, a third cap adapted to be placed in sealed relation over the third opening, a third spray nozzle adapted to operably attach to the third tank, and a third shut off for selectively shutting off the flow of fluid to the third spray nozzle, wherein at least one of the third tank, the third cap, the third spray nozzle and the third shut-off are of a third color, different from the first and second colors, indicative of the third chemical.
